(19) United States
(12) Patent Application Publication
(10) Pub. No.: US 2002/0147626 A1
(43) Pub. Date: Oct. 10, 2002

(54) System for and method of implementing a shared strategic plan of an organization

(76) Inventors: Robert J. Zagotta, Chicago, IL (US); Donald E. Robinson, Chicago, IL (US); Charles A. Arnold, Chicago, IL (US)

Correspondence Address: MICHAEL BEST & FRIEDRICH, LLP, 100 E WISCONSIN AVENUE, MILWAUKEE, WI, 53202, US

(21) Appl. No.: 09/844,259

(22) Filed: Apr. 27, 2001

Related U.S. Application Data
(60) Provisional application No. 60/281,677, filed on Apr. 5, 2001.

(51) Int. Cl. G06F 17/60

(52) U.S. Cl. 705/9

(57) ABSTRACT

A system for strategy management within an organization. The system includes a shared strategic plan, and a first processing device controllable by a user having a user identification. The first processing device includes a first communications module operable to communicate the user identification, to communicate a request to receive at least a portion of the shared strategic plan, and to receive the requested portion after communicating the user identification and the request. The system further includes a second processing device. The second processing device includes an administration module operable to validate that the user has permission to receive the requested portion, and a communications module. The communications module is operable to receive the user identification from the first processing device, and to communicate the requested portion to the first processing device when the user identification is valid.

### RELATED APPLICATIONS

This application claims the benefit of prior filed co-pending U.S. provisional patent application No. 60/281,677, entitled INTEGRATED STRATEGY MANAGEMENT TOOL, filed on Apr. 5, 2001.

### BACKGROUND OF THE INVENTION

The invention relates to a system for and method of implementing a shared strategic plan of an organization, and particularly to a system for and method of implementing a shared strategic plan that provides a mechanism to communicate a strategic plan to members of the organization.

Many organizations spend a great deal of time and effort (e.g., once a year) producing detailed organization strategies in writing. Throughout the course of the period, they spend a greater amount of time doing the work involved in conducting their operations. However, these two areas of activity are seldom integrated. That is, the day-to-day activity is not directly connected to the organization strategy. The periodic planning exercise may effectively chart a direction, but does not enable continuous course corrections to ensure that the strategic objectives are met.

One reason for the disconnect is that the strategic planning exercise involves a proportionately tiny segment of the organization. Even the best communicators cannot effectively convey the organization's strategy and describe all of its implications on day-to-day work to the organization's work force.

### SUMMARY OF THE INVENTION

It would be beneficial to have an organization planning system that allows an organization's personnel, who implement the day-to-day activities, to have direct access to the plan including how day-to-day activities relate to the organization's strategies. Additionally, it would be beneficial to have an organization planning system that can readily modify a strategic plan to match available resources and changes within the organization or the economic environment in which the organization operates. Accordingly, in one embodiment the invention provides a planning tool whereby creators of a strategic plan may incorporate day-to-day activities into the plan. The tool allows individuals performing day-to-day activities to view how their activities fit within the overall plan.

The planning tool brings an organization's entire strategic framework “on-line.” The tool allows the organization's strategy to be effectively communicated throughout all levels of the organization, and facilitates management of the organization.

The process works by obtaining specific details about an organization's vision and strategy, and building the details into a readily understood framework that is also readily internalized by the entire organization. The framework is loaded into a planning tool. The tool is accessible via a network (e.g., the organization's Intranet or the Internet), which enables the entire organization to see the strategic direction of the organization and to link their daily activities to that strategy. Linking the activities allows the organization to determine exactly how an individual may affect the strategy, and allows the management team to see a real-time view of the progress being made towards achieving the organization's strategic goals. Once all the information is within the tool, all of the parties involved, from the strategy-planning executive team to the personnel conducting day-today activity may see, update, and, if necessary, alter the organization direction. This draws everyone in the organization into the strategy management process, and transforms the strategy planning exercise into a continuous, real-time strategy management operation.

In another embodiment, the invention provides a system for strategy management within an organization. The system includes a shared strategic plan having a first level, a first sublevel with an inferior relationship to the first level, and a second sublevel with an inferior relationship to the first sublevel. The system further includes a first processing device controllable by a user having a user identification, a second processing device coupled to the first processing device. The first processing device includes a first memory device, and a first communications module. The first communications module is operable to communicate the user identification to the second processing device, to communicate a request to receive at least a portion of the shared strategic plan, and to receive the requested portion from the second processing device after communicating the user identification and the request. The second processing device includes a second processor, a second memory device that stores the shared strategic plan, an administration module operable to validate whether the user has permission to receive the requested portion, and a second communications module. The second communications module is operable to receive the user identification from the first processing device, to receive the request from the first processing device, and to communicate the requested portion to the first processing device when the user identification is valid. The system further includes an output device coupled to the second processing device that communicates the requested portion of the shared strategic plan to the user.

The invention also provides a method of implementing a shared strategic plan of an organization. The method includes creating a shared strategic plan, and storing the same at a server. The strategic plan includes a first level, a first sublevel with an inferior relationship to the first level, and a second sublevel with an inferior relationship to the first sublevel. The method further includes, transmitting a user identification to the server, transmitting a request to receive at least a portion of the shared strategic plan to the server, receiving the requested portion from the server after transmitting the user identification and the request, and transmitting the requested portion to a user after receiving the requested portion. The method further includes validating that the user has permission to receive the requested portion.

Other features and advantages of the invention will become apparent to those skilled in the art upon review of the following detailed description, claims, and drawings.

### BRIEF DESCRIPTION OF THE DRAWINGS

FIG. 1 is a schematic representation of a system embodying the invention.

FIG. 2 is a block diagram representing an example organization including multiple units.

FIG. 3 is a block diagram representing an example organization or unit captured by the system of the invention.

FIG. 4 is a representative view of an overview area.

FIG. 5 is a representative view of a progress area.

FIG. 6 is a representative view of a notes area.

FIG. 7 is a representative view of a first action plan area presented by commitment.

FIG. 8 is a representative view of a second action plan area presented by strategy.

FIG. 9 is a representative view of a vision area.

FIG. 10 is a representative view of a research center area.

FIG. 11 is a representative view of a strategy details area.

FIG. 12 is a representative view of a contact area.

### DETAILED DESCRIPTION

Before any embodiments of the invention are explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” “having,” and variations thereof herein is meant to encompass the items listed thereafter and equivalents thereof as well as additional items.

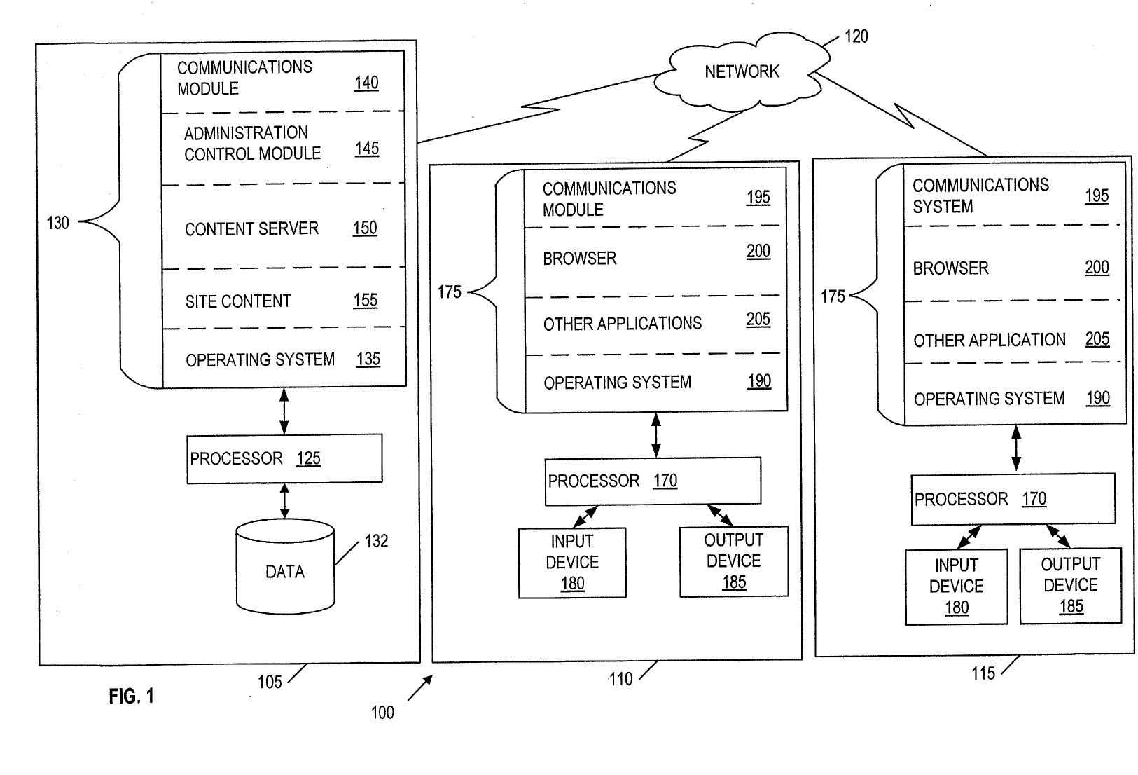

An organization planning system 100 according to one embodiment of the invention is shown in FIG. 1. As used within this application, the term “organization” means any association, group, club, society, institute, union, party, business, company, concern, corporation, establishment, outfit, partnership, firm, enterprise, venture, government agency or similar entity engaged in the provision of products or services, regardless of whether such activity is undertaken for profit. As is discussed further below, the organization may include any number of sub-organizations. Both the organization and the sub-organization may be referred to as “units.” As shown in FIG. 1 the system 100 generally includes a first processing device 105, second and third processing devices 110 and 115, and a network 120.

In the embodiment shown, the first processing device 105 acts as a server. The first processing device 105 includes one or more processors (schematically shown as 125) and one or more memory devices (schematically shown as 130). As used herein, the term “processor” means one or more processors, and the term “memory device” means one or more memory devices. The processor 125 obtains, interprets, and executes instructions stored as one or more software modules in the memory device 130. The first processing device 105 may include or be coupled to one or more databases 132.

The software modules include an operating system 135, a communications module 140, an administration control module 145, a content server 150, and site content 155. The operating system 135 includes software that controls the allocation and use of hardware resources of the processing device 105. The communications module 140 includes software that controls the allocation and use of communication hardware resources for providing communications between the first processing device 105 and the network 120. The administration control module 145 includes software that provides administration support for the first processing device 105, including validating user name and passwords. The content server 150 includes software that generates a planning tool for creating, maintaining, and communicating a strategic plan to the second and third processing devices 110 and 115. The content (such as HTML and similar files) for the planning tool is stored as site content 155. The memory device 130 may include other modules that include instructions for performing other functions, which will become apparent below.

Of course, one skilled in the art would realize that the functions performed by the first processing device 105 may be performed by any number of processors or memory devices, including local and remote processors or memory devices. A suitable processing device for the invention is a Compaq Proliant DL360 brand server with a Microsoft NT 4.0 Enterprise Addition brand operating system and a FrontPage 2000 brand intranet site server. Other processing devices 105 may be used as is known in the art. A suitable database 132 for the invention is a Compaq Proliant CL 380 brand server including a Microsoft NT 4.0 Enterprise Edition brand operating system. Other databases 132 may be used as is known in the art.

As noted, the organization planning system includes second and third processing devices 110 and 115. These devices act as clients. Although only two clients are shown, the system 100 may include any number of such processing devices. The second and third processing devices 110 and 115 are substantially similar and only device will be described in detail.

The second processing device 110 generally includes a processor (schematically shown as 170), a memory device (schematically shown as 175), one or more input devices 180, and one or more output devices 185. The processor 170 obtains, interprets and executes instructions stored as one or more software modules in the memory device 175. Additionally, the processor 170 obtains, interprets and executes instructions communicated from the first processing 105 as part of the planning tool. The input device 180 provides an interface between an operator or user and the second processing device 110, and receives data provided by the user. The input devices 180 may include a keyboard, a pointing device, a touch screen, a microphone, a magnetic-disk drive, a CD-ROM drive, a DVD-ROM drive, a communications system for receiving data from another device, or other input devices. The output device 185 provides an interface between the second processing device 110 and the user, and communicates data from the second processing device 110 to the user. The data output devices 185 may be a visual-display device (e.g., a monitor, a touch screen, etc.), a hard-copy device (e.g., a printer), a magnetic-disk drive, a CD-ROM write drive, a DVD-ROM write drive, an audio speaker, a communication system for transmitting data to another device, or other output devices.

The software modules of the second processing device 110 include an operating system 190, a communications module 195, a browser 200, and other applications 205. The operating system 190 includes software that controls the allocation and use of hardware resources of the second processing device 110. The communications module 195 includes software that controls the allocation and use of communications hardware resources of the second processing device 110 for providing communications between the second processing device 110 and the network 120. The browser 200 includes software instructions that allow the user to view the content provided to the second processing device 110 via the network 120. The other applications 205 include software instructions that control the input device 180 and the output device 185. Other modules may be used as appropriate. Other functions performed by the second processing device 110 will become apparent in the description below.

The second and third processing devices 110 and 115 may be personal computers or other devices such as personal-data assistants, handheld computers, laptop computers, Internet/Intranet appliances, and similar devices.

Preferably, the network 120 is a packet-switch-based network based on IP protocols, and may include wire and/or wireless communications. A network suitable for use in the invention is an Intranet network. However, other networks are possible including the Internet and even non-IP based systems.

Having described the basic architecture of the system 100, its operation will now be explained. For the embodiment shown in FIG. 1, a user (e.g., an administrator, an employee, etc.) accesses the network 120 (e.g., the Intranet) via the second processing device 110. The user navigates through content of the tool 120 by linking from Intranet page to Intranet page as is well known in the art. In general, the user navigates the planning tool to create a strategic plan, to view at least a portion of the strategic plan, and/or to edit the strategic plan.

Creating a Strategic Plan

Upon accessing the planning tool, the user enters a user name and password (also referred to as user identification). As should be apparent to those of ordinary skill in the art, the term “user” sometimes refers to a “physical” user and other times refers to a variable or object that represents the real-world user. The planning tool verifies that the user accessing the tool has the proper permission or clearance (herein after referred to as “permission”) to create a strategic plan. Assuming the user has proper permission, an overview area is provided to the user, including virtual buttons and/or menus, for creating the strategic plan.

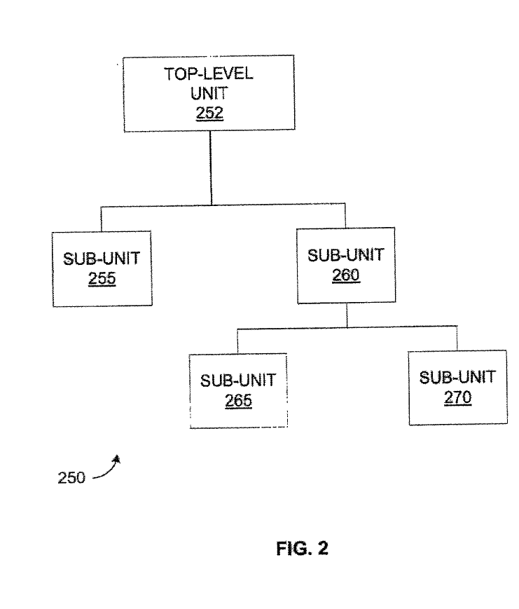

The planning tool allows a user to create a strategic plan for an organization 250. The planning tool organizes the organization by units. If the organization includes only one unit, then the organization is that one unit. However, the organization 250 may include multiple units 252, 255, 260 and 270, in which case the organization 250 includes a top or first level unit 252, and sub-organizations or sub-units 255, 260, 265 and 270. As shown in FIG. 2, units 252, 255, 260, 265 and 270 are organized into a hierarchy by assigning a parent/child relationship between the multiple units. In one embodiment, each unit 252, 255, 260, 265 and 270 includes it own separate plan. For purposes of brevity only one unit and one plan will be described in detail.

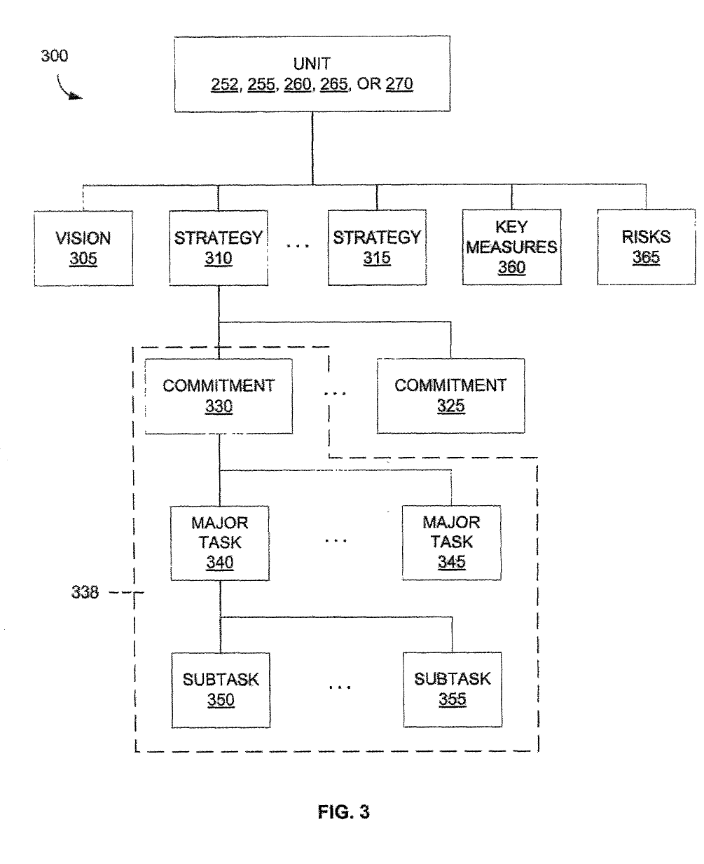

FIG. 3 illustrates a strategic plan 300 for a unit 252, 255, 260, 265 or 270. The strategic plan 300 includes a vision 305 and one or more strategies 310 and 315. The vision 305 is typically for the unit and includes a vision statement and vision elements. However, the vision may be a shared vision; that is, a vision shared by more than one unit. The vision statement includes text serving as a guiding statement for the specified unit, and the vision elements include specific, measurable, outcome-oriented quantitative measures that define where the unit will be at a specific point and time. In other words, the vision 305 answers the question “where is the unit going?”

Strategies 310 and 315 are action statements that describe how the vision will be realized or implemented. In other words, the strategies answer the question “How is the vision going to be obtained?” Strategies 310 and 315 typically span multiple periods (e.g., multiple years), and drive commitments and action plans (discussed below) for other planning units throughout the organization. For one embodiment, each strategy 310 and 315 include a mantra and a strategy description. The mantra provides a focussed, short description of the strategy, and the strategy description more thoroughly defines the mantra.

The strategies (e.g., 310) are defined by one or more action plans (e.g., 338), which include one or more commitments 330 and 335. The commitments provide specific business results intended for the respective strategy, and are measurable goals or initiatives tied to specific, measurable, organization or unit results. Every commitment supports a strategy and has a designated owner. Commitments are stated in varying degrees of detail and result in varying degrees of time to complete.

The commitments (e.g., 330) are further defined, which include one or more major tasks 340 (may also be referred to as “tasks”). The major tasks 340 and 345 define the work that needs to occur to achieve the respective commitment. The major tasks (e.g., 340) may include one or more subtasks 350 and 355 that define the work that needs to occur to achieve the major task 340.

The terms “vision,” “strategy,” “commitment,” “action plan,” “major task,” and “sub-task” are only exemplary labels and other labels or terms are capable of being used to describe the related function. For maximum flexibility, the planning tool allows an organization to use a set of custom labels or terms. Customizing labels allows for a smoother merging of the tool's methodology with an organization's existing written strategic plan.

As shown in FIG. 3, the vision 305, the strategies 310 and 315, the commitments 330 and 335, the major tasks 340 and 350, and the sub-tasks 350 and 355 are organized in a hierarchy of levels and sublevels. Other levels may be added to the plan. For example, subtasks may include further subtasks. Similarly, other information or sections may be added. For example, the plan may include a key measures area 360 and a risk area 365. The key measures area 360 includes measures or indicators indicating how successful the unit is at achieving the quantifiable vision measures. The risks area 365 includes text-based description of risks that might impact a strategy. The terms “key measures” and “risks” are only exemplary labels. Other labels or terms are capable of being used to describe the related function.

When creating the plan, a user having appropriate permission creates an initial plan by entering the plan into the second processing device 110. The second processing device 110 communicates the entered plan to the first processing device 105, where the first processing device 105 stores the plan. Once the plan is stored, users at the second and third processing devices 110 and 115 may view and edit the plan as disclosed below. The plan includes a vision, at least one strategy, and at least one action plan for the organization.

Every item in the plan (e.g., strategies, commitments, major tasks and subtasks) has an owner or assigned individual. The owner (may also be referred to as the “administrator” of the item) is assigned to follow up and assure the completion of the work at hand for the assigned item. For example, a CEO or President of the organization is the owner of the organization level. By assigning an individual to an item, the tool grants that individual administrative (i.e., viewing and editing) permission for that item. Additionally, the tool indicates to all users that this person is ultimately responsible for how successful the unit is at achieving the item. As will be discussed below, the owner's name is listed immediately after each item in the displayed plan and includes a link or communication mechanism to communicate with the owner. Following the owner's name is a date, which indicates the date that item was last modified. The terms “owner,” “items,” and “assigned individual” are only exemplary labels with other labels or terms capable of being used to describe the related function.

Strategy management is a real-time process. As such, new items are constantly being added and old items are being taken away. The planning tool handles constant change by having draft and active modes. These modes allow the current strategy to remain uncluttered, while insuring that new and old items are readily accessible. Active mode provides day-to-day editing and viewing. Draft mode is used to create and edit large number of items in preparation for future organization efforts. That is, draft mode is used to work on new strategic plans before they are ready to be viewed by the organization. An administrator can create or significantly revise a plan in draft mode and release the plan to active mode upon completion. In the active mode, users can view the released plan and update or edit the plan as needed.

Viewing and Editing at Least a Portion of a Strategic Plan

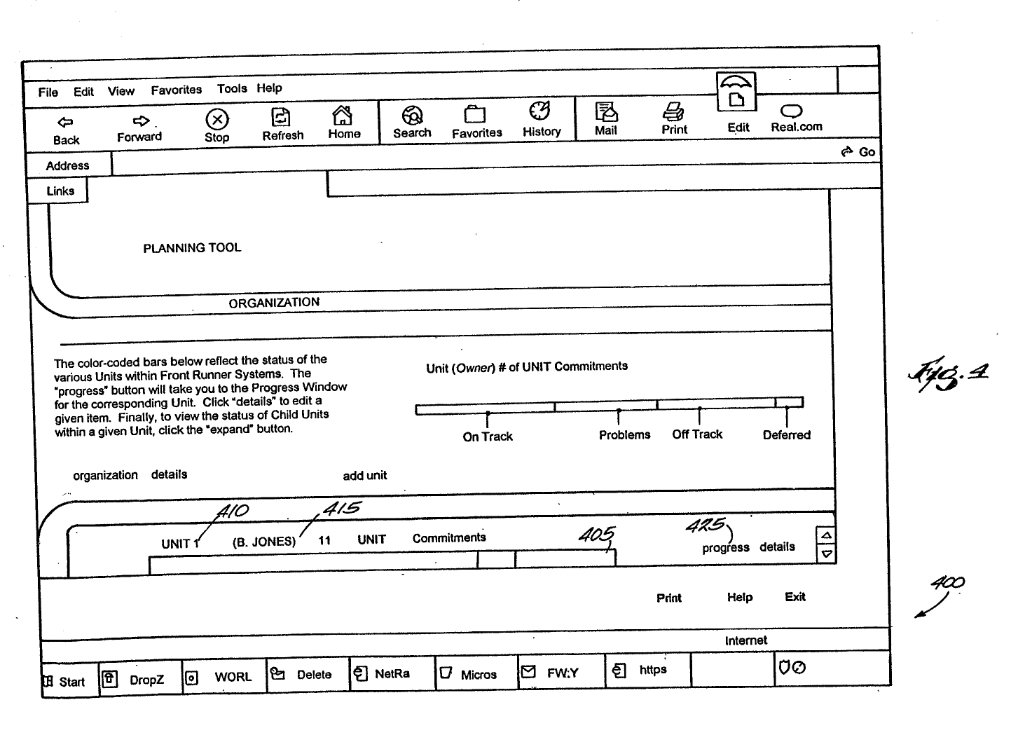

Upon accessing the planning tool, the user enters a user name and password. The planning tool uses the user name and password (the “user identification”) to verify that the user has the proper permission or clearance to view at least a portion of the strategic plan. Assuming the user has proper authority, the user is brought to an overview area 400 (FIG. 4). By using the term area, one skilled in the art will realize that the information provided by one area may be disclosed in one or more screens and/or one or more display windows or frames. For example, the information provided in the overview area may be provided in multiple frames or in just one frame. Further, for the embodiment described below, the information and data is divided among multiple areas. However, the specific information that is provided in any particular area may change. For example, it is envisioned that in one embodiment of the invention all information is provided in just one expansive area.

The overview area 400 displays the names of the units for which the user has permission to view. For example and as was discussed above, each item is assigned an individual to perform the assigned tasks. The tool grants the user permission to view the name of the units that include the user's assigned items. For example and as shown in FIG. 4, the user is granted permission to view “UNIT 1 ”. Additionally, a user may not be assigned an item, but may be granted permission to view certain aspects or portions of the plan.

The overview area 400 shows the highest level summary the user has permission to access. The access could be at the organization or top-unit level, or the sub-unit level. In one embodiment, one purpose of the overview page is to provide the executive team (i.e., the team that creates the vision, strategies, and commitments) with the visual representation of the organization. For “executive” users, the overview page provides a list of all organizations or units, provides buttons for modifying these items, and provides a status indicator 405 for each item. In a second embodiment, not all users have access to all features of the overview page. For “non-executive” users, the overview area 400 displays a status indicator 405 for the unit the user has permission to view.

The overview area 400 provides a summary of each unit capable of being displayed. The summary includes the name of the unit 410, the individual owner 415, and the status indicator, such as status bar 405, having the total number of commitments associated with the given unit. Preferably, the status bar 405 is divided into coded parts to help define the unit status. For example, the status may be divided into four color-coded parts: red for “off track,” yellow for “problems,” green for “on track,” and blue for “deferred.” Of course, other colors may be used and the number of coded parts may vary.

Each part of the status bar 405 is based on the summary status of all the commitments to which the bar 405 relates. Assuming the user has the appropriate permission, the user may expand the status bar 405 allowing the user to look inside a specific unit, edit an existing unit, and/or add a unit.

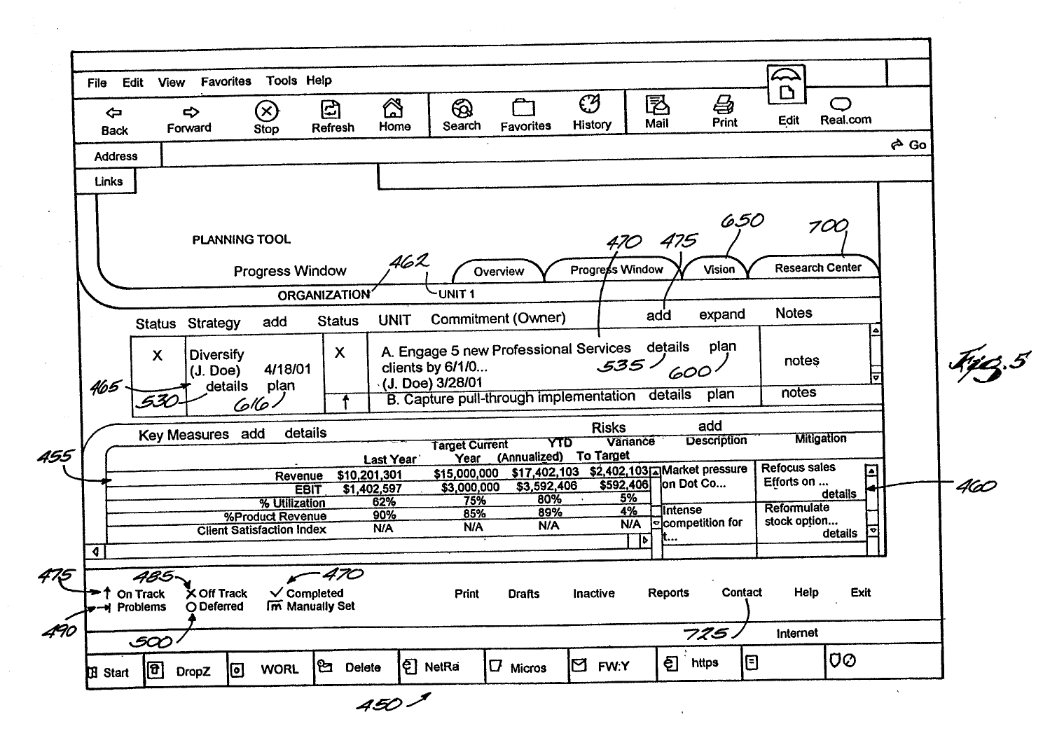

From the overview area 400, the user may link to a progress area for any units the user has permission to view by pressing progress button 425 (FIG. 4). The progress area 450 (FIG. 5) is the centerpiece of a given unit's strategic plan and allows real-time management of the strategic plan. The progress area 450 provides a high level view of the unit's progress towards achieving its specific goals, provides information on key business measures 455 and potential risks 460, and provides access to the action plans and day-today functions, including providing status of all strategies and commitments.

In the progress area 450, the organization and unit name 462 are displayed near the top of the area 450. The user views the strategies 465 for the unit and the commitments 470 associated with each strategy by scrolling down the strategy frame. The user, with appropriate permission, can add new strategies and commitments from the progress window by activating add button 475.

As was stated above, to ensure accountability, all items (e.g., strategies, commitments, major tasks, etc.) have owners. For each item displayed, the owner's name is next to the item. The user may click on the owner's name to link the user to a contact area (discussed below). The contact area provides a communication mechanism for allowing the user to access contact information (e.g., telephone number and email address) for the owner and to communicate with the owner (e.g., via email). Further, a date accompanies the owner's information and indicates when that item was last modified. In one embodiment, dates may be highlighted in red to indicate that the item has changed since the last login by the user.

Any item may include a descriptor or icon (collectively referred to as “descriptor”) that indicates the progress or status made toward achieving the item. Typically, the owner of the icon manually sets the status, however the status may be automatic. For one embodiment, there are six possible status descriptors that can be attributed to any item. A completed descriptor 470 indicates an item is complete. An on track descriptor 475 indicates the end date or revised end date of the item has not passed and is on track for completion by the assigned end date. An update descriptor (not shown) indicates the end date has not passed, but no one has modified the task within the past thirty days. A problem descriptor 485 indicates that there is a potential risk of not completing the item by the assigned end date. An off track descriptor 490 indicates that the specific item's end date has passed and that the item is off track. A hold descriptor 500 indicates that an item is on hold and is not being actively statused. In one embodiment, only the strategies, commitments, major tasks and sub-tasks include a descriptor. The terms “completed,” “on track,” “update,” “problem,” “off track,” and “hold” are only exemplary labels with other labels or terms capable of being used to describe the related function.

Key measures 455 indicate how successful the unit is at achieving the quantifiable business measures. For one embodiment, key measures are facts or statistics and the value for a specific statistic related to the unit is not necessarily tied to goals. Only individuals with appropriate permissions are allowed access to view and modify key measures.

Risks 460 are text-based descriptions of specific issues or events that might impact a strategy. Only users with appropriate permissions are able to view or modify risks. Each risk includes one or more mitigation descriptions that describe how the organization is addressing a particular risk. Like notes (described below), risks and mitigations can be updated frequently to reflect up-to-the-minute information.

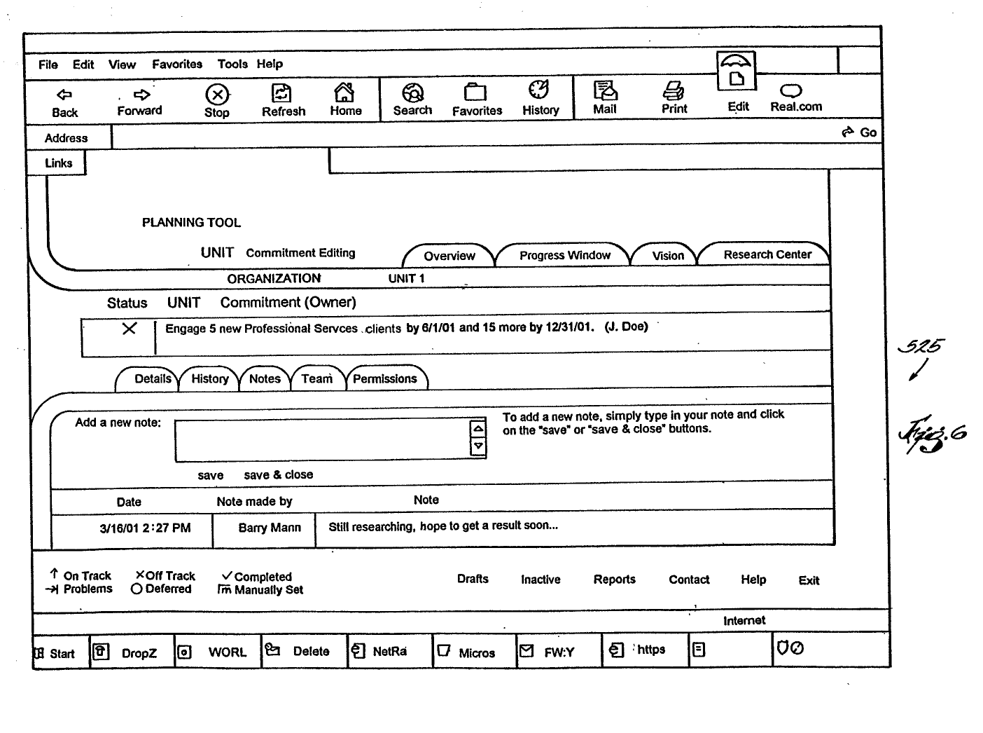

Any item may include an area for notes. Notes allow for ongoing updates and comments through which the owner or other users with proper permission can communicate pertinent information to others involved in achieving the item. In one embodiment, only the commitments, major tasks, and sub-tasks include a notes section. For example, from the progress area 450, each commitment includes a respective notes button that allows the user to directly link to the notes area 525 (FIG. 6). Other notes sections are accessed similarly. The term “notes” is only an exemplary label. Other labels or terms are capable of being used to describe the related function.

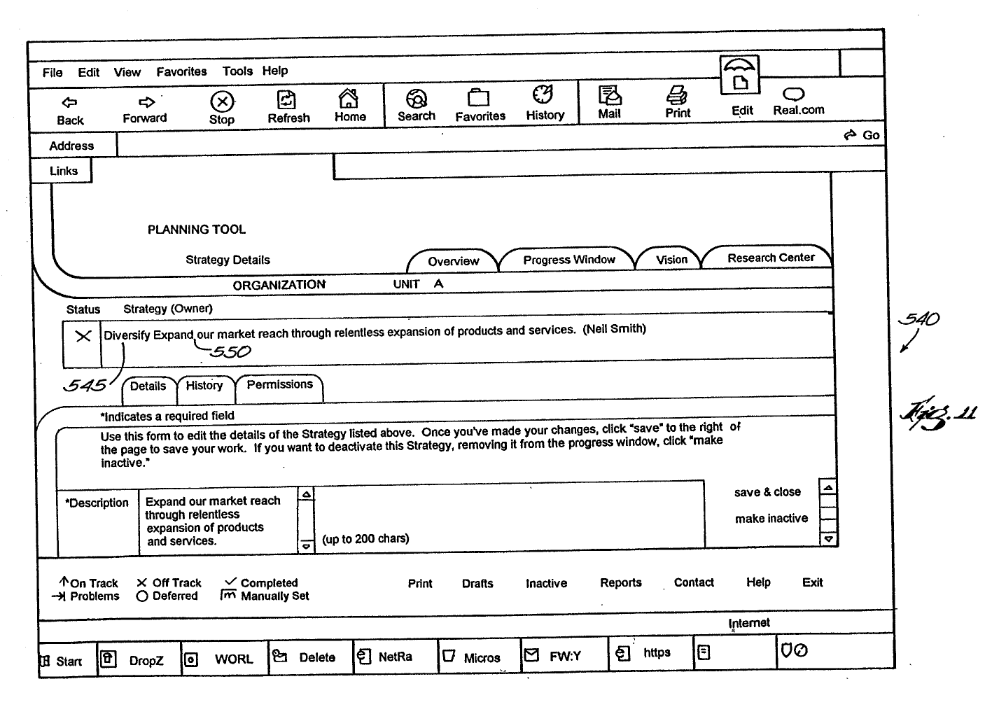

Referring back to FIG. 5, every item includes a details button (e.g., 530 or 535) that links the user to a details area for the item. For example, the details button 530 links the user to a strategy details area 540 (FIG. 11) for the strategy “diversify.” In the details area, the user views detailed information about the specific item, including the full text of the item. For example, in the strategy details area 540, the user views a mantra 545 and a strategy description 550. In addition and assuming the user has proper permission, the user may edit the item. Other details buttons work similarly. The term “details” is only an exemplary label and other labels or terms are capable of being used to describe the related function.

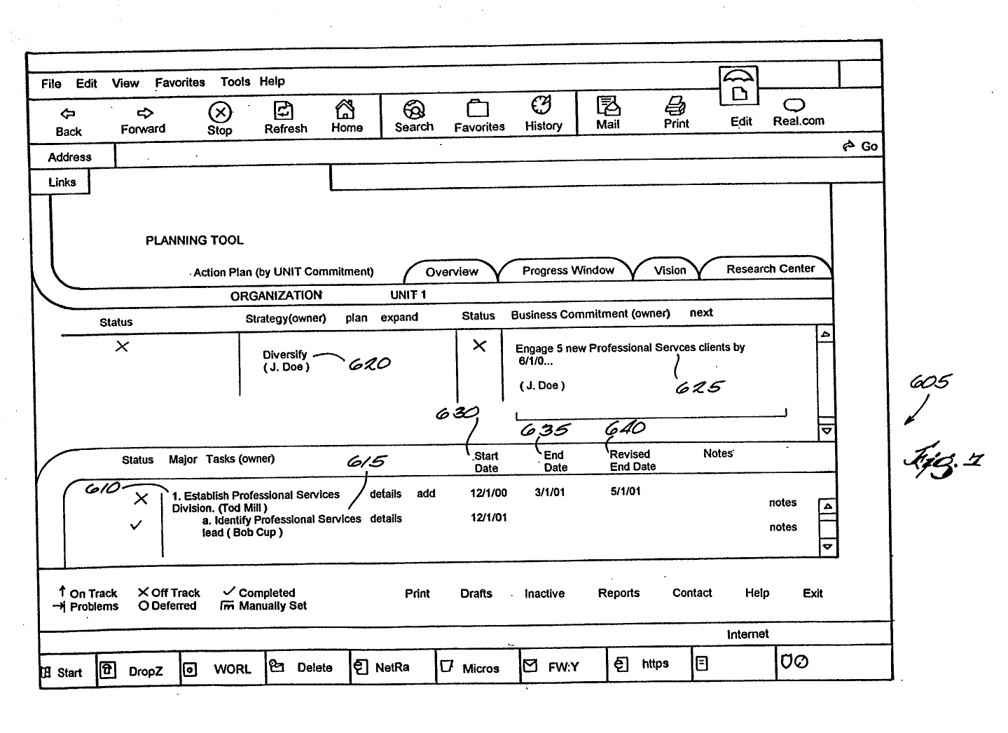

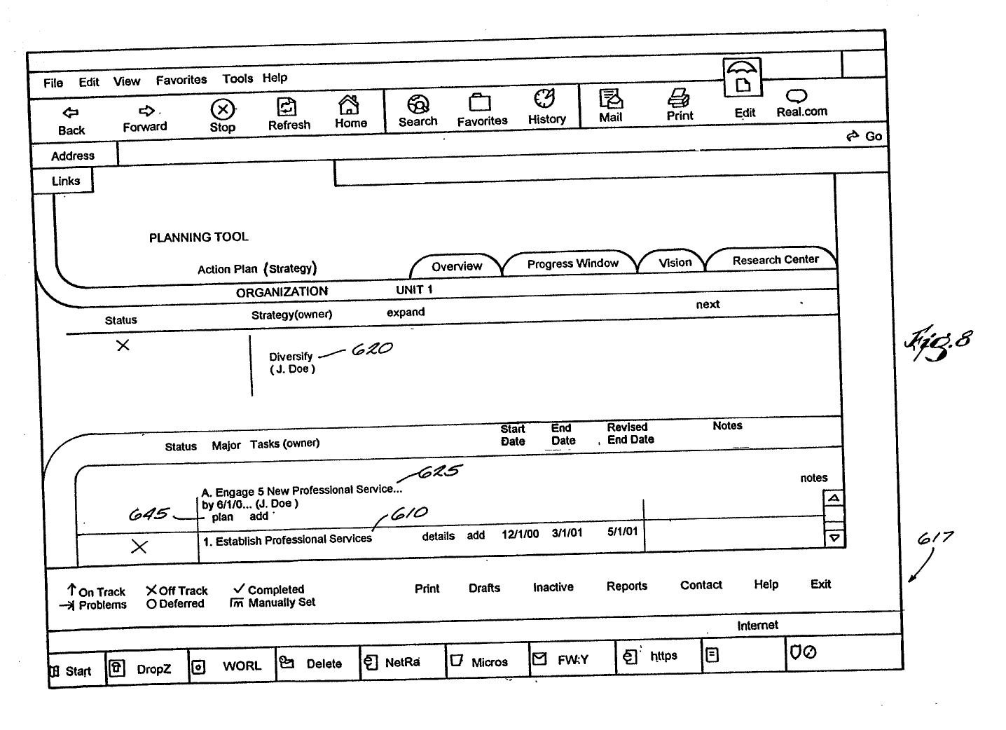

Every commitment also includes a plan button (e.g., 600) that allows users to view action plans. For example, if the user operates the plan button 600, the user is linked to an action plan area 605 (FIG. 7), which includes major tasks 610 and subtasks 615 for the respective commitment. If the user operates strategy plan button 616 (FIG. 5), the user is linked to the action plan area 617 (FIG. 8), which includes the commitments, major tasks, and sub tasks for the respective strategy. From the action plan area 605 or 617, the user is able to view the details of the plan (e.g., major tasks 610 and sub-tasks 615 for area 605). Assuming appropriate permission, the user can edit the items and create new items within the area.

An action plan is the set of actions required to meet a specific strategy or commitment. An action plan answers the question “what has to be done in order to meet the strategy or commitment?” Progress is then monitored against the action plans. As shown in FIG. 7, the action plan area 605 for a commitment 625 provides a sequential listing of the major tasks 610 and sub-tasks 615 listed for the commitment 625. Each major task 610 and sub-task 615 has a notes feature that works similarly to the commitment note feature. The notes features allows the assigned owner to provide an ongoing log of comments. The action plan also has a details button that takes the user to the appropriate details area for reviewing or modifying elements of the plan.

Major tasks and subtasks 610 and 615 include a start date 630, an end date 635, and a revised end date 640. The dates for a major task are based on all of the its subordinate subtasks, which require the user to enter at least a start date and an end date. The early start date and latest end date of the subtasks determine the start and end dates of the major tasks. The proximity in time to the end date for the major tasks determines the status for the tasks and for any commitment the major task is linked. Tasks also display owner names and modification dates just as on the process window.

As shown in FIG. 8, when the user selects the action plan for a strategy, the user will see a single strategy 620 at the top of the page and a list that separates the major tasks 610 and sub-tasks (not shown) into groups according to commitments 625. In one embodiment, it is possible to link major tasks to more than one commitment and, therefore, major tasks may appear multiple times on the same area 617. From this area, the user can access the action plan area (e.g., 605) for a specific commitment by selecting the plan button 645 next to the commitment.

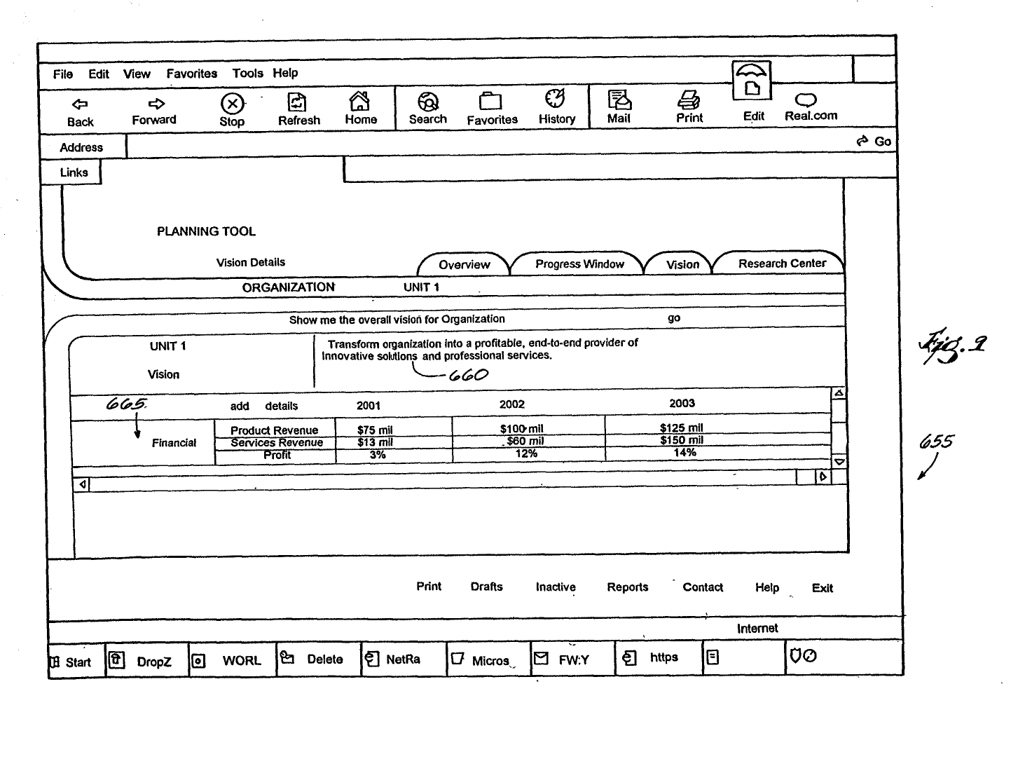

Referring back to FIG. 5, from the progress area 450, the user may link to a vision area by activating the vision tab 650. The vision area 655 (FIG. 9) includes a vision statement 660 and vision elements 665. The vision statement 660 includes text serving as a guiding statement for the specified unit, and the vision elements 665 include a set of quantitative measures that describe where the organization will be at a specific point and time. Each unit may have a vision that is focused on milestones and goals that are considered key to the unit's contribution to the broader activity of reaching goals of the organization's shared vision. Examples of vision elements include product review, locations, profits, number of employees, percent of available employees, etc. In one embodiment, the planning tool allows the user to group vision elements into four categories “financial,” “customer/market,” “infrastructure/process,” and “people.” Milestones are key measurement dates for the specified unit and display as column headings on the vision page. With the appropriate permissions, the user can add or delete a vision milestone and change the display order. Of course, other elements can be added or the above element names may be modified.

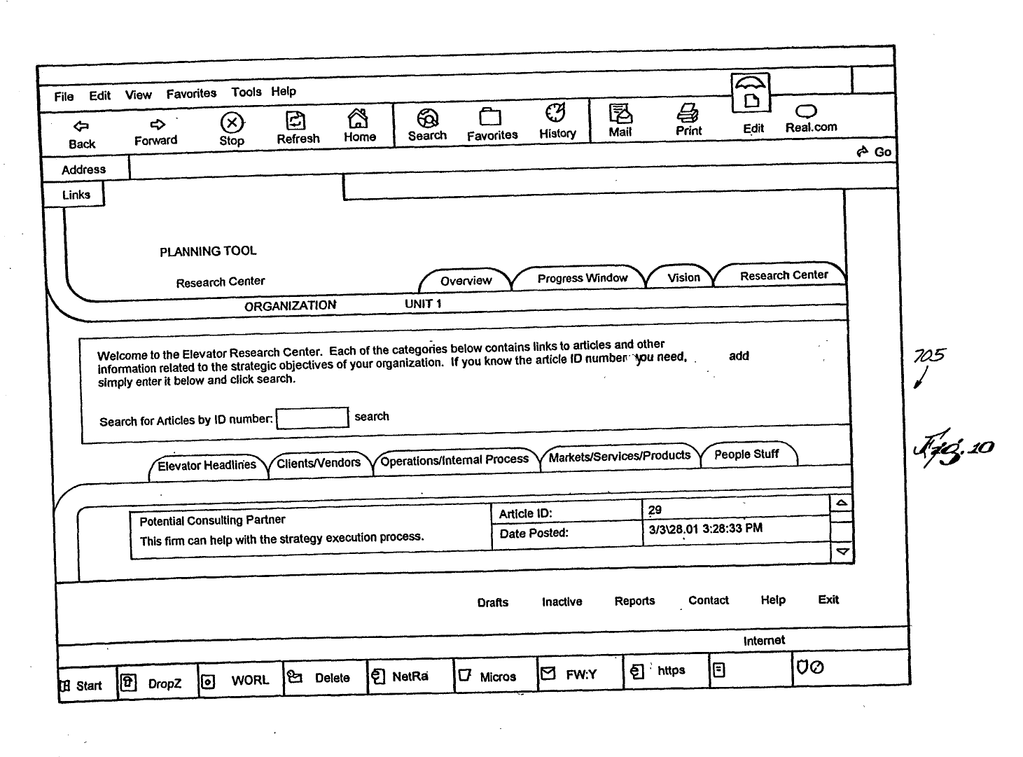

Referring back to FIG. 5, the user may link from the progress area 540 to a research center area by activating the research center button 700. The research center area 705 (FIG. 10) serves as a central repository for links to web-based articles and other information related to the unit's strategy. For example, in one embodiment, links are provided to five categories: “headlines;” “client/vendors;” “operations/internal processes;” “market/services/products;” and “people stuff.” Each of the categories contain links to articles and other information related to the specific objectives of the organization. Each link includes a name and description, the date the link was posted to the tool, and the name of the individual who posted the link.

Assuming the user has proper authority, the user may link to a security administration area (not shown). The security administration area allows the user (e.g., an administrator or owner of an item) to manage permissions of one or more items of the strategic plan. Every item in the planning tool has permission levels associated with it for each user. In one embodiment, four levels of permission are available: none (user has no access to see the item), reviewer (user has access to see the item, but cannot make any edits to the item), editor (user can see and edit the item, but cannot make changes to permission levels), and administrator (user can change any aspect of the item, including permission levels of other users to that item).

The entire structure of the planning tool is arranged in a hierarchy. The security of the planning tool is designed such that rights flow down through the hierarchy. In general, if a user has rights to a given item, he will have the same rights to every item below. For example, if a user has editor rights to a unit, he will have editor rights to everything in that unit as well as to any child units. The propagation is automatic and happens as soon as the original rights are granted.

The most common trigger for the automatic propagation is the assignment of ownership. When a user is made the owner of an item, he is automatically made an administrator of that item. This triggers the automatic propagation of administrator rights to all sub items. Automatic propagation of administrator rights allows the administrator to assign access (e.g., viewer permission) to the item and sub items under his authority.

There are two exceptions to the simple automatic propagation rules. First, administrator rights do not flow unit to unit. For example, if the user is the administrator of one unit that has five child units, he will have administrator rights to everything in the original unit, but will only have editor rights to the child units. This exception to the propagation rule is designed to ensure that the unit owner has complete control of the unit.

The second exception occurs with rights under strategies. If the user has rights to an element under a strategy such as a commitment, those rights will automatically flow down to all subitems (action plans) of the commitment. However, in addition to the downward propagation, the user will be given reviewer rights to the strategy itself, which will in turn flow down to all the other commitments in that strategy. This change to the standard rule is designed to ensure that users responsible for accomplishing tasks can see the context of those tasks, including the strategy they are intended to help accomplish and the other commitments that are related.

In every case, taking a user's rights away has the reverse effect of the original propagation. The most common application of this rule is the re-assignment of ownership. If someone's ownership rights are taken away, so too are their administrator rights to that item, as well as the rights to all subitems. This “de-propagation” continues downstream until it a) flows through all items in the hierarchy or b) encounters an item for which the user is still the owner. In the case of b), the user's rights remain as administrator for the owned item and its subitems.

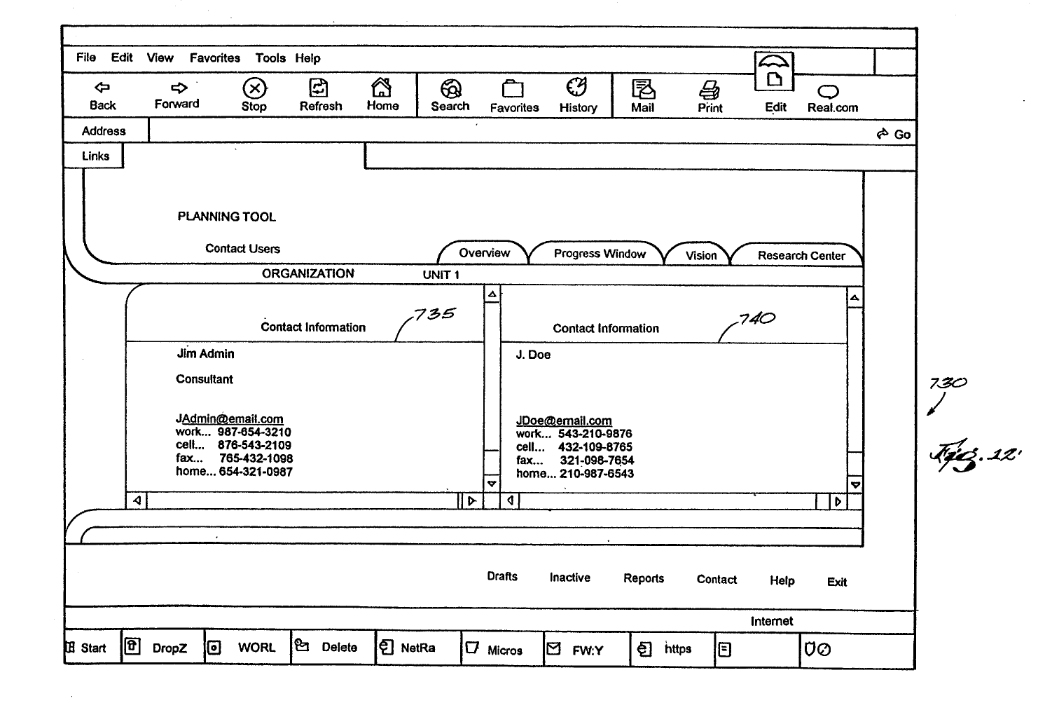

The tool also includes a contact area 730 (FIG. 12). After activating a contact link, the user is taken to the contact area 730 (FIG. 12). The contact link may be at the bottom of any area (e.g., button 725, FIG. 5), or may be an owner's name (discussed above). The contact area 730 provides a mechanism for allowing the user to contact or communicate with other individuals or groups using the tool. Initially, the user sees up to two pieces of information in the contact area. First, the user receives the contact card 735 for the administrator of the tool (if linking from the bottom of an area), or the contact card for the administrator or owner of the item from which the user linked. Second, in the upper right hand corner, the user sees his contact card 740. The second contact card allows the user to update his contact information as needed. The communication facility provided by the contact area 730 helps ensure timely implementation of tasks and other activities of the strategic plan.

As can be seen from the above, the invention provides a useful system for and method of implementing a shared strategic plan of an organization. Various features and advantages of the invention are set forth in the following claims.

What is claimed is:

1. A system for strategy management within an organization, the system comprising:
a shared strategic plan having a first level, a first sublevel with an inferior relationship to the first level, and a second sublevel with an inferior relationship to the first sublevel;
a first processing device controllable by a user having a user identification, the first processing device including
a first memory device, and
a first communications module operable to communicate the user identification, to communicate a request to receive at least a portion of the shared strategic plan, and to receive the requested portion after communicating the user identification and the request;
a second processing device coupled to the first processing device, the second processing device including
a second memory device that stores the shared strategic plan,
an administration module operable to validate the user identification has permission to receive the requested portion, and
a second communications module operable to receive the user identification from the first processing device, to receive the request from the first processing device, and to communicate the requested portion to the first processing device when the user identification is valid; and
an output device coupled to the second processing device that communicates the requested portion of the shared strategic plan to the user.

2. A system as set forth in claim 1 wherein the shared strategic plan includes a vision that sets a goal, and wherein the first level includes a strategy that describes how the vision is implemented.

3. A system as set forth in claim 2 wherein the user is assigned to implement the strategy, and wherein the administration module is further operable to assign viewer permission to the user allowing the user to receive a portion of the shared strategic plan relating to the strategy when the user is assigned the strategy.

4. A system as set forth in claim 3 wherein the requested portion of the shared strategic plan includes the strategy, the first sublevel, and the second sublevel.

5. A system as set forth in claim 3 wherein the first communications module is further operable to communicate an edit that changes the strategy, wherein the administration module is further operable to assign edit permission to the user allowing the user to edit the strategy when the user is assigned the strategy and to validate that the user has edit permission.

6. A system as set forth in claim 2 wherein the first sublevel includes a commitment that specifies an intended result for the strategy.

7. A system as set forth in claim 6 wherein the user is assigned to implement the commitment, and wherein the administration module is further operable to assign viewer permission to the user allowing the user to receive a portion of the shared strategic plan relating to the commitment when the user is assigned the commitment.

8. A system as set forth in claim 7 wherein the portion of the shared strategic plan receivable by the user includes the strategy, the commitment, and the second sublevel.

9. A system as set forth in claim 7 wherein the first communications module is further operable to communicate an edit that changes the commitment, wherein the administration module is further operable to assign edit permission to the user allowing the user to edit the commitment when the user is assigned the commitment and to validate that the user has edit permission.

10. A system as set forth in claim 6 wherein the second sublevel includes a task that defines the work to occur for achieving the commitment.

11. A system as set forth in claim 10 wherein the user is assigned to implement the task, and wherein the administration module is further operable to assign viewer permission to the user allowing the user to receive a portion of the shared strategic plan relating to the task when the user is assigned the task.

12. A system as set forth in claim 11 wherein the requested portion of the shared strategic plan includes the strategy, the commitment, and the task.

13. A system as set forth in claim 11 wherein the first communications module is further operable to communicate an edit that changes the task, wherein the administration module is further operable to assign edit permission to the user allowing the user to edit the task when the user is assigned the task and to validate that the user has edit permission.

14. A system as set forth in claim 10 wherein the shared strategic plan further includes a third sublevel with an inferior relationship to the second sublevel, and wherein the third sublevel includes a subtask that defines the work to occur for achieving the task.

15. A system as set forth in claim 1 wherein the first and second processing devices are coupled via the Internet.

16. A method of implementing a shared strategic plan of an organization, the method comprising:
creating a shared strategic plan and storing the same in memory, the strategic plan including a first level, a first sublevel with an inferior relationship to the first level, and a second sublevel with an inferior relationship to the first sublevel;
sending a request to receive at least a portion of the shared strategic plan from one device to another;
sending a user identification with the request;
validating that a user associated with the user identification has permission to receive the requested portion; and
transmitting the requested portion when the user identification is valid; and
communicating the requested portion to the user after receiving the requested portion.

17. A method as set forth in claim 16 wherein creating the shared strategic plan further includes creating a vision that sets a goal for the unit, and wherein creating a strategy includes creating a statement that describes how the vision is implemented.

18. A method as set forth in claim 17 wherein the method further comprises assigning the user to implement the strategy, and assigning viewer permission to the user allowing the user to receive a portion of the shared strategic plan relating to the strategy.

19. A method as set forth in claim 18 wherein the requested portion of the shared strategic plan includes the strategy, the first sublevel, and the second sublevel.

20. A method as set forth in claim 18 wherein the method further comprises:
communicating an edit that changes the strategy;
assigning edit permission to the user when the user is assigned the strategy;
validating the user identification to ensure that the user is permitted to edit the strategy; and
editing the strategy when the user identification is valid.

21. A method as set forth in claim 17 wherein creating the first sublevel includes creating a commitment that specifies an intended result for the strategy.

22. A method as set forth in claim 21 wherein the method further comprises assigning the user to implement the commitment and assigning viewer permission to the user allowing the user to receive a portion of the shared strategic plan relating to the commitment when the user is assigned the commitment.

23. A method as set forth in claim 22 wherein the requested portion of the shared strategic plan includes the strategy, the commitment, and the second sublevel.

24. A method as set forth in claim 22 wherein the method further comprises:
communicating an edit that changes the commitment;
assigning edit permission to the user when the user is assigned the commitment;
validating that the user is permitted to edit the commitment; and
editing the commitment when the user permission is valid.

25. A method as set forth in claim 21 wherein creating the second sublevel includes creating a task that defines the work to occur for achieving the commitment.

26. A method as set forth in claim 25 wherein the method further comprises:
assigning the user to implement the task;
assigning viewer permission to the user; and
allowing the user to receive a portion of the shared strategic plan relating to the task when the user is assigned the task.

27. A method as set forth in claim 26 wherein the requested portion of the shared strategic plan includes the strategy, the commitment, and the task.

28. A method as set forth in claim 26 wherein the method further comprises:
communicating an edit that changes the task;
assigning edit permission to the user;
validating the that the user is permitted to edit the task when the user is assigned the task; and
editing the task when the user permission is valid.

29. A method as set forth in claim 25 wherein the shared strategic plan includes a third sublevel with an inferior strategy to the second sublevel, the third sublevel having a task.

30. A method as set forth in claim 16 wherein the sending a request and communicating the request portion are via the Internet.

31. A strategic planning tool comprising:
a strategic plan stored in memory and accessible by a plurality of users, the strategic plan including a first level and at least one sublevel;
an overview area with a status indicator divided into coded parts;
a progress area including one or more commitments, a details link, a plan link, and a commitment status indicator;
a research area; and
a contact area.

32. A planning tool as set forth in claim 31 wherein the status indicator is a status bar.

33. A planning tool as set forth in claim 31 wherein the strategic plan includes a unit, and wherein the status indicator conveys the status of the unit.

34. A planning tool as set forth in claim 33 wherein the first level includes a strategy for the unit, wherein the first sublevel includes the one or more commitments, wherein the one or more commitments are commitments for the strategy, and wherein each coded part conveys the status of a respective commitment.

35. A planning tool as set forth in claim 33 wherein the overview area includes a progress link corresponding to the status indicator, and wherein the progress link connects the overview area to the progress area.

36. A planning tool as set forth in claim 31 wherein the strategic plan further includes a unit, wherein the first level includes a strategy for the unit, wherein the first sublevel includes the one or more commitments, wherein the one or more commitments are for the strategy, and wherein the progress area communicates the unit and the strategy.

37. A planning tool as set forth in claim 36 wherein the progress area further includes a strategy status indicator.

38. A planning tool as set forth in claim 36 wherein the progress area further includes key measures indicating the success of the unit.

39. A planning tool as set forth in claim 36 wherein the progress area further includes risks that might impact the strategy.

40. A planning tool as set forth in claim 31 wherein the progress area further includes a contact link that connects the progress area to the contact area.

41. A planning tool as set forth in claim 31 wherein the planning tool further comprises a vision area with a vision for the unit, and wherein the progress area further includes a vision link that connects the progress area to the vision area.

42. A planning tool as set forth in claim 31 wherein the progress area further includes a contact link that connects the progress area to the contact area.

43. A planning tool as set forth in claim 42 wherein the contact area includes information for an administrator.

44. A planning tool as set forth in claim 31 wherein the progress area includes a research link that connects the progress area to the research area.

45. A planning tool as set forth in claim 44 wherein the research area includes one or more information links.

46. A planning tool as set forth in claim 31 wherein the details link connects the progress area to a details area.

47. A planning tool as set forth in claim 31 wherein the plan link connects the progress area to an action plan area having an action plan.

48. A planning tool as set forth in claim 31 wherein the strategic plan includes at least two units, the number of units being represented by (n).

49. A planning tool as set forth in claim 48 wherein the plurality of users include a first group of users, wherein the overview area is accessible by the first group of users, wherein each unit includes a status indicator, and wherein the overview area displays each status indicator when a user of the first group of users accesses the overview area.

50. A planning tool as set forth in claim 49 wherein the plurality of users include a second group of users, wherein the overview area displays less than (n) status indicators when a user of the second group of users accesses the overview area.

51. A method of implementing a shared strategic plan, the method comprising:
creating the shared strategic plan including a unit having a plurality of levels, each level having at least one item;
making the shared strategic plan accessible to a plurality of users;
assigning each item to a respective user;
providing an overview of at least a portion of the strategic plan to the users including providing a status indicator indicating the status of the unit;
presenting progress of the unit to the plurality of users;
providing a contact area allowing the users to communicate with each other.

52. A method as set forth in claim 51 wherein the method further comprises creating a research area.

53. A method as set forth in claim 52 wherein the creating a research area includes creating one or more information links.

54. A method as set forth in claim 51 wherein the status indicator is a status bar.

55. A method as set forth in claim 51 wherein the unit is a first unit, wherein the shared strategic plan includes a second unit having a plurality of levels, and wherein providing an overview of at least a portion of the strategic plan available to the users includes providing an overview of the first and second units to a first group of users, and providing an overview of the first unit to a second group of users.

56. A method as set forth in claim 51 wherein the method further comprises allowing each assigned user to edit the respective item.

57. A method as set forth in claim 51 wherein the providing a status indicator includes dividing the status indicator into coded parts, each coded part conveys the status of a respective commitment.

58. A method as set forth in claim 51 wherein the creating the shared strategic plan includes creating one or more strategies for the unit, and creating one or more commitments for each strategy, and wherein the presenting progress of the unit includes presenting progress of the strategy, and presenting progress of the commitment.

59. A method as set forth in claim 58 wherein the presenting progress of the strategy includes presenting a strategy status indicator indicating the status of the strategy.

60. A method as set forth in claim 58 wherein the presenting progress of the commitment includes presenting a commitment status indicator indicating the status of the commitment.

61. A method as set forth in claim 58 and further comprising presenting risks that might impact the strategy.

62. A method as set forth in claim 51 wherein the presenting progress of the unit includes presenting measures indicating the success of the unit.

63. A method as set forth in claim 51 wherein the method further comprises presenting a vision of the unit to the plurality of users.

64. A method as set forth in claim 51 wherein the creating the shared strategic plan includes creating one or more strategies for the unit, and creating one or more action plans for each strategy, and wherein the method further comprises presenting the action plan to the plurality of users.

65. A method as set forth in claim 64 wherein the creating one or more action plans includes creating one or more tasks, and wherein the presenting the action plan includes presenting the one or more tasks.
